(19) United States
(12) Patent Application Publication
(10) Pub. No.: US 2010/0008606 A1
(43) Pub. Date: Jan. 14, 2010

(54) SLIDING SUPPORT ASSEMBLY

(75) Inventor: Andrew Neil Craddock, Northhampton (GB)

Correspondence Address: Stephen B. Salai, Esq.;Harter Secrest & Emery LLP, 1600 Bausch & Lomb Place, Rochester, NY, 14604-2711, US

(73) Assignee: Accuride International Ltd., Northhampton (GB)

(21) Appl. No.: 12/438,424

(22) PCT Filed: Aug. 22, 2007
(86) PCT No.: PCT/GB07/03212

§ 371 Date: Feb. 23, 2009

(30) Foreign Application Priority Data
Aug. 23, 2006 (GB) 0616733.2

(51) Int. Cl. F16C 29/02

(52) U.S. Cl. 384/26

(57) ABSTRACT

The present invention relates to sliding support assemblies and particularly sliding supports having two (or more) elongate members, which slide one within the other. The invention addressed the problem of shearing between a pair of such sliding supports used on an article which may be subjected to forces from several directions and which may cause one or both of the supports to jam. The problem is addressed by the arrangement of the elongate members on a sliding support assembly. The invention also provides a locking mechanism for locking an article being supported by the sliding support assembly in place relative to a base of the assembly.

The invention relates to sliding support assemblies.

It is known to provide sliding supports for drawers, such sliding supports having two (or more) elongate members, typically of shallow channel section, which slide one within the other, one of the members being secured to the drawer and the other to the frame or housing in which the drawer is supported. Sliding engagement between the members is typically provided by ball bearings retained by a retaining member located between the two elongate members.

In an arrangement for supporting an article, for example a drawer, where a sliding support, having a pair of sliding members as outlined above, is arranged on each side of the article, the sliding support is arranged with the channels of the members opening horizontally partly because this takes up little lateral space, and partly because the sliding support is designed to bear vertical load in this orientation.

If sliding supports of this type are used with a heavy article, for example a heavy drawer, or an article which may be subjected to forces from several directions, for example, an automotive arm rest or centre console, a problem of shearing between the sliding supports arises, which may cause one or both of the supports to jam.

According to a first aspect of the invention, there is provided a sliding support assembly comprising:
a base;
a support element for supporting an article to be slidably mounted on the base; and
a pair of spaced apart slides slidably connecting the base to the support element to provide parallel sliding movement of the base relative to the support element, each slide comprising a pair of elongate members slidably engaged one with the other, one elongate member of each slide being fixed relative to the base and the other elongate member of each slide being fixed relative to the support element, the two elongate slide members fixed relative to the base lying in different planes which diverge in a direction extending from the base towards the support element.

By arranging the slide members so that they lie in planes which diverge from the base towards the support element, the problem of shearing when a force is applied to the support element is prevented. The angled slides prevent the assembly failing when a force is applied to the article in a lateral direction relative to the direction of sliding movement.

The elongate member of each slide fixed to the support element preferably has a planar base and side walls extending from the planar base to define a slide channel, and the elongate member of each slide fixed relative to the base preferably engages within the respective slide channel. By arranging the elongate member which is fixed to the base within the channel formed by the elongate member fixed to the support element, the weight of the article being supported tends to maintain the slide in its desired configuration rather than working to pull the slide apart.

The slides are preferably formed separately from the base and the support element, one of the elongate slide members of each slide being attached to the base and the other elongate slide member of each slide being attached to the support element. Accordingly, standard known slides can be incorporated into the assembly. Alternatively, the elongate members can be formed integrally with the base and the support element so that two separately extruded, molded or otherwise formed pieces are required to form the assembly.

The base preferably has at least one slide support wing on each side thereof, the support wings lying in different planes corresponding to the planes of the elongate slide members fixed relative to the base. Preferably the planes of the elongate slide members lie at equal angles relative to a general plane of the base.

In a preferred embodiment the base is substantially of W profile in cross section. Preferably, the W-profile base has an elongate central planar portion.

The sliding support assembly also preferably includes a locking mechanism for locking the base and the support element in a desired position. The locking mechanism preferably includes a locking device movably mounted on the support element.

When the base is substantially of W profile in cross section with an elongate central planar portion and the sliding support assembly includes a locking mechanism for locking the base and the support element in a desired position, the locking mechanism preferably comprises a series of notches along the edges of the elongate central portion of the base, and a locking device movably mounted on the support element, the locking device having protuberances engageable with the notches when the locking mechanism is in a locking position.

According to a further aspect of the invention, there is provided a sliding support assembly comprising:
a base of substantially W profile in cross section and having an elongate central planar portion;
a support element slidably mounted on the base; and
a locking mechanism for locking the base and the support element in a desired position, the locking mechanism comprising a series of notches along the edges of the elongate central portion of the base, and a locking device movably mounted on the support element, the locking device having protuberances engageable with the notches when the locking mechanism is in a locking position.

By using the edges of the elongate central portion of the base as part of the locking mechanism, the tolerances of the assembly are improved, and the locking mechanism securely locks the support element directly and securely to the base.

The locking device preferably includes a flap of hat-channel profile having a web, a first leg extending at a first angle from a first end of the web, a second web extending at the first angle from a second end of the web, a first flange extending at a second angle from the first leg, and a second flange extending at the second angle from the second leg, the protuberances being formed by a series of slots formed where the first and second flanges extend from the first and second legs.

The flap is preferably mounted on the support element, the flap being movable between a locking position in which the flap lies against the base, with a plurality of the protuberances engaged in a plurality of the notches in the base, and a release position in which the protuberances are disengaged from the notches.

The locking device may be pivotally mounted on the support element. Alternatively, the locking device may include a sprung section for enabling the locking device to be moved from a locking position to a release position.

The sliding support assembly preferably further comprises a mechanism for moving the locking device relative to the support element.

The mechanism for moving the locking device may comprise a suitable means for causing the locking device to move from the locked position to the release position. The mechanism may comprise a lever having a first end connected to the support element and a second end connected to the locking device, and an actuator connected to the lever. The actuator may be located on the sliding support assembly, on the article supported by the sliding support assembly or mounted away from the assembly. The actuator may be hand driven or motor driven. In a preferred embodiment the actuator comprises a wire drive mechanism, for example a Bowden™ cable.

Once the locking mechanism has been actuated to release the support element from the base, the article being supported can be moved relative to the base. Movement of the article can be carried out by applying a force to the article by hand. Alternatively, movement of the article relative to the base can be motor driven.

By way of example, an embodiment of a sliding support assembly according to the invention will now be described with reference to the accompanying drawings, in which:

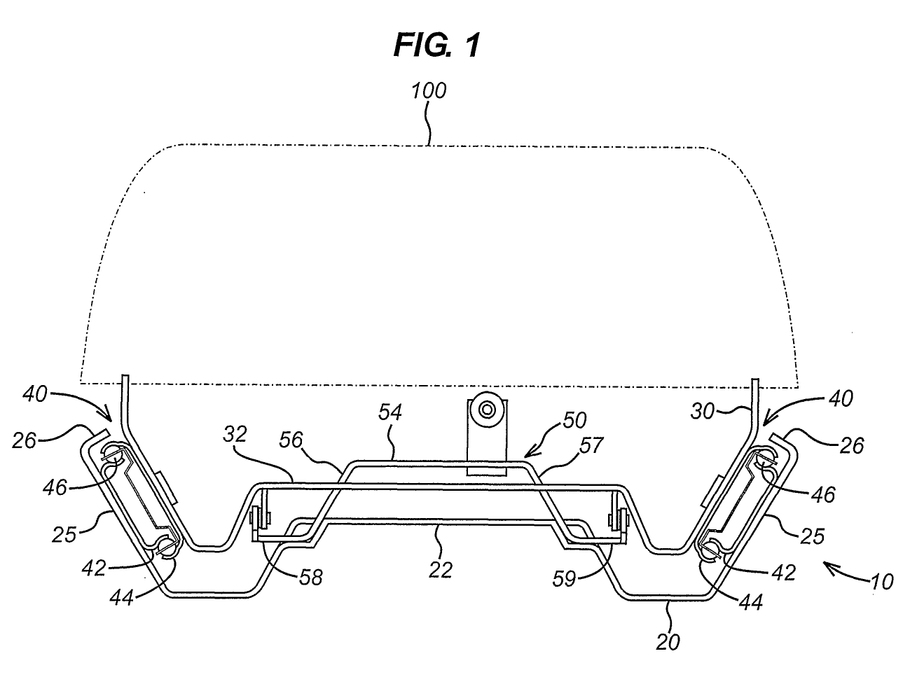

FIG. 1 is a sectional view of a sliding support assembly according to the invention;

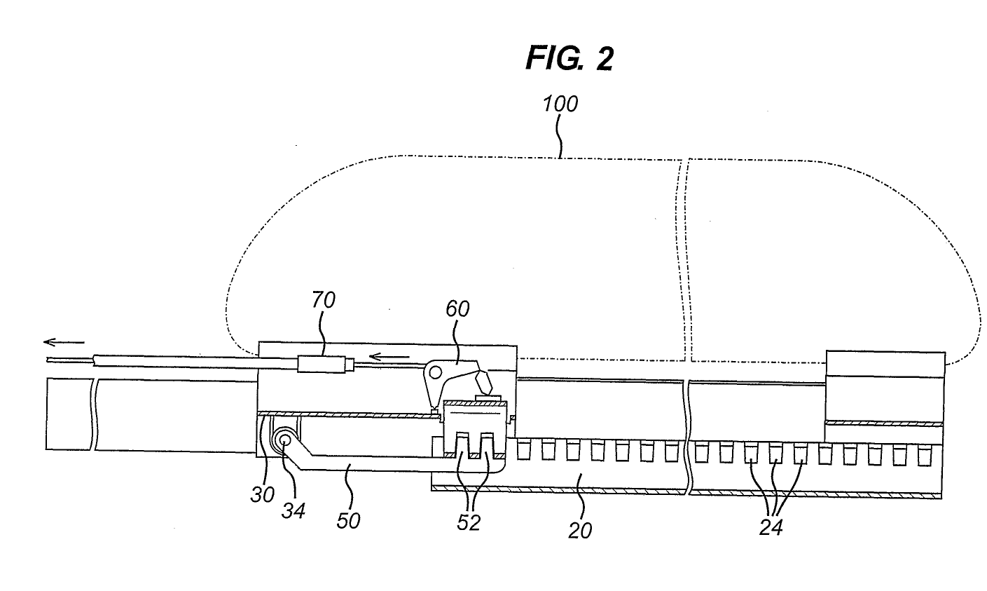

FIG. 2 is a side view of the sliding support assembly of FIG. 1 in a first position;

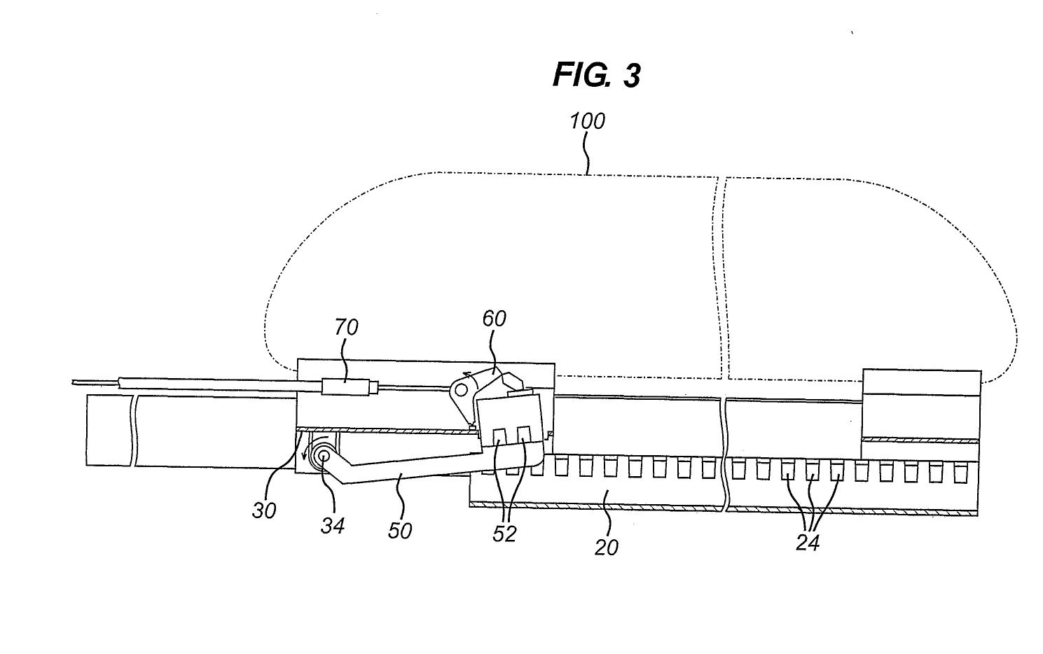

FIG. 3 is a side view of the sliding support assembly of FIG. 1 in a second position;

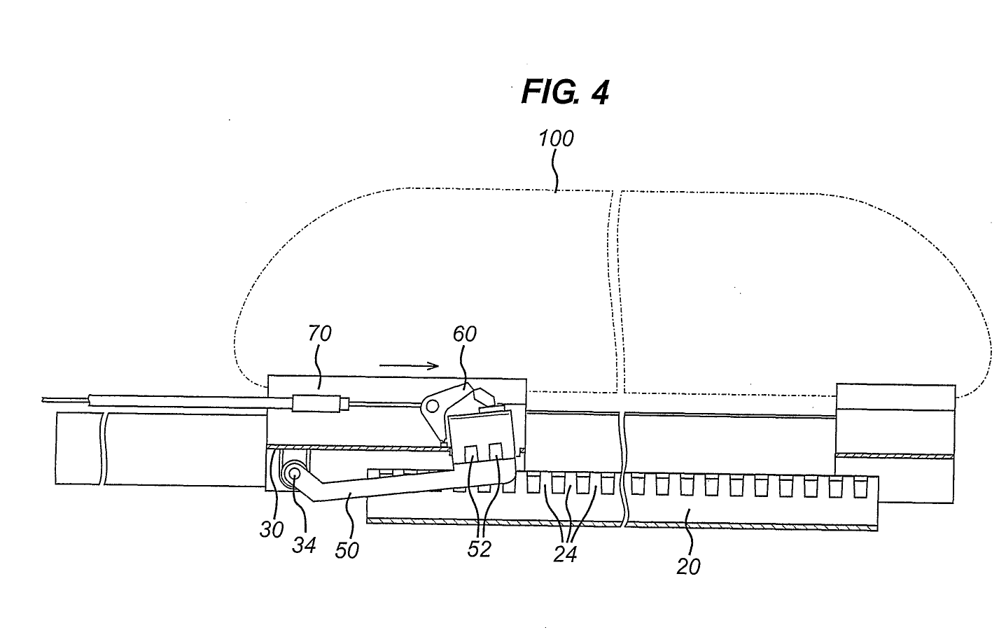

FIG. 4 is a side view of the sliding support assembly of FIG. 1 in a third position;

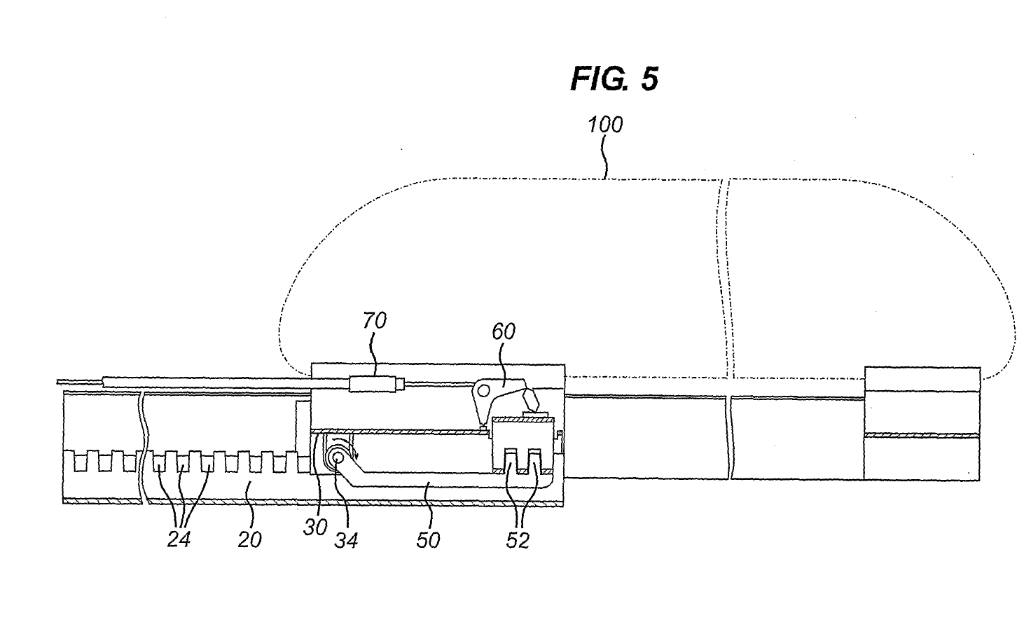

FIG. 5 is a side view of the sliding support assembly of FIG. 1 in a fourth position.

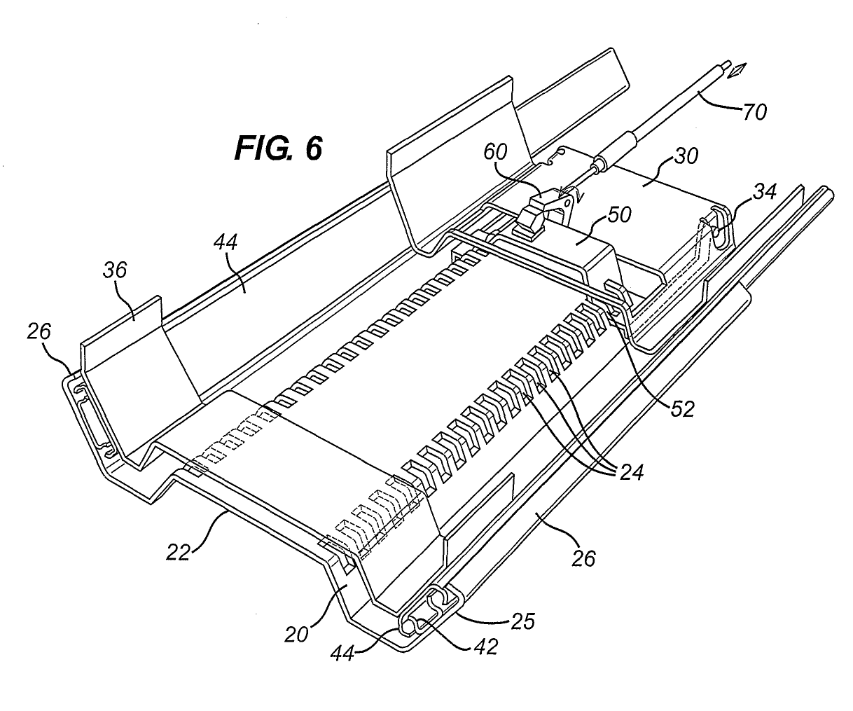

FIG. 6 is a perspective view of the sliding support assembly of FIG. 1.

FIG. 1 shows a sectional view of an embodiment of a sliding support assembly generally indicated at 10.

The sliding support 10 has a base 20, a support element 30 for supporting an article 100 to be slidably mounted on the base 20, and a pair of spaced apart slides 40 slidably connecting the base 20 to the support element 30 to provide parallel sliding movement of the base 20 relative to the support element 30.

The support element 30 supports, in this example, an automotive centre console shown schematically at 100 and secured to the support element 30 by suitable means (not shown). The sliding support assembly 10 can, however, slidably support any element or body required to be linearly movably mounted.

Each slide 40 comprises a pair of elongate members 42, 44 slidably engaged one with the other, one elongate member 42 of each slide 40 is fixed relative to the base 20 and the other elongate member 44 of each slide 40 is fixed relative to the support element 30. The two elongate slide members 42, 44 are fixed relative to the base 20 lying in different planes which diverge in a direction extending from the base 20 towards the support element 30.

The elongate member 44 of each slide fixed to the support element 30 has a planar base and side walls extending from the planar base to define a slide channel, and the elongate member 42 of each slide fixed relative to the base 20 also has a planar base and side walls extending from the planar base. The elongate member 42 engages slidingly within the respective slide channel. The side walls of the elongate members 42 and 44 include curved ball engagement profiles respectively in which ball bearings 46 run. The elongate members 42 and 44 are made of mild steel (or other suitable material).

The elongate member 44 comprises the outer member of the slide and the elongate member 42 comprises the inner member of the slide. By having the elongate member 42 which is fixed to the base 20 as the inner member and the elongate member 44 which is fixed to the support element 30 as the outer member, the weight of the article 100 being supported tends to maintain the slide in its desired configuration rather than working to pull the slide apart.

The slides 40 are formed separately from the base 20 and the support element 30. Accordingly, standard slides are incorporated into the assembly.

The base 20 is substantially of W profile with an elongate central portion 22. The support element 30 is also substantially of W profile with an elongate central portion. Accordingly, the base includes a slide support wing 25 on each side thereof, the support wings lying in different planes corresponding to the planes of the elongate slide members 42 fixed relative to the base 20. The planes of the elongate slide members 42 lie at equal angles relative to a general plane of the base. The elongate central portion 22 lies in the general plane of the base 20.

Base 20 also include a wraparound feature 26 at the end of each slide support wing 25 which prevents the slides 40 being ripped apart if an upward force is applied to the article 100 in the configuration shown in FIG. 1.

The sliding support assembly also includes a locking mechanism for locking the base 20 and the support element 30 in a desired position. The locking mechanism includes a locking device 50 movably mounted on the support element 30.

The locking mechanism comprises a series of notches 24 along the edges of the elongate central portion 22 of the base 20, and a series of protuberances 52 along an edge of the locking device 50 which are engageable with the notches 24 when the locking mechanism is in a locking position.

The locking device 50 comprises a flap of hat-channel profile having a web 54, a first leg 56 extending at a first angle from a first end of the web 54, a second web 57 extending at the first angle from a second end of the web 54, a first flange 58 extending at a second angle from the first leg 56, and a second flange 59 extending at the second angle from the second leg 57, the protuberances 52 being formed by a series of slots formed where the first and second flanges 58, 59 extend from the first and second legs 56, 57.

The flap is mounted on the support element 30, and is movable between a locking position in which the flap lies against the base 20, with a plurality of the protuberances 52 engaged in a plurality of the notches 24 in the base 20, and a release position in which the protuberances 52 are disengaged from the notches 24.

The locking device 50 is pivotally mounted on the support element 30 at pivot point 34.

The sliding support assembly also comprises a mechanism for moving the locking device 50 relative to the support element 30. The mechanism for moving the locking device 50 comprises a lever mechanism 60 for causing the locking device 50 to move from the locked position to the release position upon actuation by a wire drive mechanism 70 such as a Bowden™ cable. A first end of the lever 60 is connected to the support element 30 and a second end of the lever 60 is connected to the locking device 50. The wire drive mechanism 70 is connected to the lever 60.

Once the locking mechanism has been actuated to release the support element from the base, the article being supported can be moved relative to the base. Movement of the article can be carried out by applying a force to the article by hand. Alternatively, movement of the article relative to the base can be motor driven.

FIGS. 2 to 5 show how the locking device 50 can be disengaged from the base 20 to allow relative movement of the support element 30 and base 20, and how the locking device 50 can be engaged with the base 20 to lock the support element 30 relative to the base 20.

In FIG. 2, article 100 attached to support element 30 is in a first position. Protrusions 52 of locking device 50 are engaged with notches 24 in base 20.

Actuation of the wire drive mechanism 70 as shown by the arrows in FIG. 2, causes lever 60 to rotate about its connection with the locking device 50 which, in turn, causes locking device 50 to rotate about pivot point 34 as shown in FIG. 3. Consequently, the locking device is now positioned in a release position in which the protrusions 52 are not engaged with notches 24.

A force can then be applied to article 100 thus causing support element 30 to slide relative to base 20 as shown in FIG. 3.

Once article 100 has been slid into its desired position, wire drive mechanism 70 can be released, thus allowing lever 60 to rotate about its connection with locking device 50, and the locking device to rotate about its pivot point 34 as shown in FIG. 5. With article 100 in its second position, protrusions 52 are now engaged with a different plurality of notches 34 thus locking the support element 30 and article 20 relative to the base 20.

As can be seen from the perspective drawing shown in FIG. 6, support element also includes an additional W profile portion 36 which is attached to elongate slide member 44 and which provides further support to article 100.

It will be appreciated that the embodiment and modification thereto are by way of example only, and that alterations or modifications may be made within the scope of the invention as defined in the appended claims.

1. A sliding support assembly comprising:
a base;
a support element for supporting an article to be slidably mounted on the base; and
a pair of spaced apart slides slidably connecting the base to the support element to provide parallel sliding movement of the base relative to the support element, each slide comprising a pair of elongate members slidably engaged one with the other, one elongate member of each slide being fixed relative to the base and the other elongate member of each slide being fixed relative to the support element, the two elongate slide members fixed relative to the base lying in different planes which diverge in a direction extending from the base towards the support element.

2. A sliding support assembly as claimed in claim 1 wherein the elongate member of each slide fixed to the support element has a planar base and side walls extending from the planar base to define a slide channel, and the elongate member of each slide fixed relative to the base engages within the respective slide channel.

3. A sliding support assembly as claimed in claim 1 wherein the slides are formed separately from the base and the support element, one of the elongate slide members of each slide being attached to the base and the other elongate slide member of each slide being attached to the support element.

4. A sliding support assembly as claimed in claim wherein the base has at least one slide support wing on each side thereof, the support wings lying in different planes corresponding to the planes of the elongate slide members fixed relative to the base.

5. A sliding support assembly as claimed in claim 1 wherein the planes of the elongate slide members lie at equal angles relative to a general plane of the base.

6. A sliding support assembly as claimed in claim 1 wherein the base is substantially of W profile in cross section.

7. A sliding support assembly as claimed in claim 6 wherein the base has an elongate central planar portion.

8. A sliding support assembly as claimed in claim 1 comprising a locking mechanism for locking the base and the support element in a desired position.

9. A sliding support assembly as claimed in claim 8 wherein the locking mechanism includes a locking device movably mounted on the support element.

10. A sliding support assembly as claimed in claim 7 comprising a locking mechanism for locking the base and the support element in a desired position, the locking mechanism comprising a series of notches along the edges of the elongate central portion of the base, and a locking device movably mounted on the support element, the locking device having protuberances engageable with the notches when the locking mechanism is in a locking position.

11. A sliding support assembly comprising:
a base of substantially W profile in cross section and having an elongate central planar portion;
a support element slidably mounted on the base; and
a locking mechanism for locking the base and the support element in a desired position, the locking mechanism comprising a series of notches along the edges of the elongate central portion of the base, and a locking device movably mounted on the support element, the locking device having protuberances engageable with the notches when the locking mechanism is in a locking position.

12. A sliding support assembly as claimed in claim 10 wherein the locking device includes a flap of hat-channel profile having a web, a first leg extending at a first angle from a first end of the web, a second web extending at the first angle from a second end of the web, a first flange extending at a second angle from the first leg, and a second flange extending at the second angle from the second leg, the protuberances being formed by a series of slots formed where the first and second flanges extend from the first and second legs.

13. A sliding support assembly as claimed in claim 12 wherein the flap is mounted on the support element, the flap being movable between a locking position in which the flap lies against the base, with a plurality of the protuberances engaged in a plurality of the notches in the base, and a release position in which the protuberances are disengaged from the notches.

14. A sliding support assembly as claimed in claim 9 wherein the locking device is pivotally mounted on the support element.

15. A sliding support assembly as claimed in claim 9 wherein the locking device has a sprung section for enabling the locking device to be moved from a locking position to a release position.

16. A sliding support assembly as claimed in claim 9, further comprising a mechanism for moving the locking device relative to the support element.

17. A sliding support assembly as claimed in claim 16 wherein the mechanism for moving the locking device comprises a lever having a first end connected to the support element and a second end connected to the locking device, and an actuator connected to the lever.

18. A sliding support assembly as claimed in claim 17 wherein the actuator comprises a wire drive mechanism.
